(19) United States
(12) Patent Application Publication
(10) Pub. No.: US 2025/0298223 A1
(43) Pub. Date: Sep. 25, 2025

(54) REFLECTION MODULE AND CAMERA MODULE INCLUDING THE SAME

(71) Applicant: Samsung Electro-Mechanics Co., Ltd., Suwon-si (KR)

(72) Inventors: Tae Won KANG, Suwon-si (KR); Jung Woo KIM, Suwon-si (KR); Jae Kyung KIM, Suwon-si (KR)

(73) Assignee: Samsung Electro-Mechanics Co., Ltd., Suwon-si (KR)

(21) Appl. No.: 18/986,669

(22) Filed: Dec. 18, 2024

(30) Foreign Application Priority Data
Mar. 22, 2024 (KR) 10-2024-0039642

(51) Int. Cl. G02B 13/00; G02B 7/182; G03B 13/36; G03B 17/12; G03B 17/17

(52) U.S. Cl. CPC G02B 13/0065; G02B 7/1821; G03B 13/36; G03B 17/12; G03B 17/17

(57) ABSTRACT

A reflection module includes: a reflection member configured to convert an incident light path; a holder, mounted with the reflection member, configured to rotate about a first rotation axis and a second rotation axis perpendicular to the first rotation axis; a housing accommodating the holder; and a first auxiliary member coupled to the holder, wherein the first auxiliary member includes a plurality of buffer members and a frame on which the plurality of buffer members are disposed, and the frame includes an inclined portion having at least a portion extending obliquely with respect to the first rotation axis or the second rotation axis.

### CROSS-REFERENCE TO RELATED APPLICATION(S)

This application claims the benefit under 35 USC 119(a) of Korean Patent Application No. 10-2024-0039642 filed on Mar. 22, 2024, in the Korean Intellectual Property Office, the entire disclosure of which is incorporated herein by reference for all purposes.

### BACKGROUND

### 1. Field

The present disclosure relates to a reflection module and a camera module including the same.

### 2. Description of the Background

A camera module may be used in a portable electronic device such as a tablet, a personal computer (PC), a laptop computer, or a smartphone.

The camera module has an autofocus (AF) function, an optical image stabilization (OIS) function, and there is a trend to add a zoom function thereto.

The camera module may implement autofocus and zoom functions by moving a lens module along an optical axis, and implement an optical image stabilization function by moving the lens module or a reflection module to intersect the optical axis.

When a camera implements the above functions, an interference may occur between components included in the camera.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a reflection module includes: a reflection member configured to convert an incident light path; a holder, mounted with the reflection member, configured to rotate about a first rotation axis and a second rotation axis perpendicular to the first rotation axis; a housing accommodating the holder; and a first auxiliary member coupled to the holder, wherein the first auxiliary member includes a plurality of buffer members and a frame on which the plurality of buffer members are disposed, and the frame includes an inclined portion having at least a portion extending obliquely with respect to the first rotation axis or the second rotation axis.

The plurality of buffer members may include a first buffer member disposed on the inclined portion, and a second buffer member spaced apart from the first buffer member.

The second buffer member may be spaced apart from the first buffer member in a second rotation axis direction.

Each of the first buffer member and the second buffer member may include a portion facing the housing, and at least a part of the portion facing the housing having a curved contour.

Each of the first buffer member and the second buffer member may include one or more damping holes passing therethrough in a thickness direction.

The first buffer member may protrude towards a side surface of the housing for a distance between the housing and the first buffer member to be closer than a distance between the housing and the holder.

The second buffer member may protrude towards a bottom surface of the housing for a distance between the housing and the second buffer member to be closer than a distance between the housing and the holder.

The holder may include: a reflection holder, mounted with the reflection member, configured to rotate about the first rotation axis, and a rotation holder, supporting the reflection holder, configured to rotate about the second rotation axis. The first auxiliary member may be coupled to the rotation holder to surround a portion of the reflection holder.

The reflection holder further may include a protrusion extending in a first rotation axis direction, and the first auxiliary member surrounding the protrusion.

The first auxiliary member may be configured to have at least a portion of the inclined portion face the protrusion, and a portion of the protrusion that faces the first auxiliary member may extend to be parallel to the inclined portion.

The first auxiliary member may be coupled to the rotation holder to be spaced apart from the housing and the reflection holder.

In another general aspect, a camera module includes a housing; a reflection module, disposed in the housing, including a reflection member; a lens module, disposed in the housing, including at least one lens; and a first auxiliary member, disposed on at least one side of the reflection module, comprising a plurality of buffer members and a frame in which the plurality of buffer members are disposed, wherein the frame has an inclined portion to which at least one of the plurality of buffer members is coupled.

The reflection module may include a holder, mounted with the reflection member, configured to rotate about the first rotation axis and the second rotation axis perpendicular to the first rotation axis. The first auxiliary member may be coupled to the holder.

The plurality of buffer members may include a first buffer member disposed on the inclined portion, and a second buffer member spaced apart from the first buffer member.

At least a portion of the plurality of buffer members may have a curved contour.

The plurality of buffer members may include one or more damping holes passing therethrough in a thickness direction.

Other features and aspects will be apparent from the following detailed description, the drawings, and the claims.

### BRIEF DESCRIPTION OF DRAWINGS

FIG. 1 is a perspective view of a camera module according to an embodiment of the present disclosure.

FIG. 2 is a schematic exploded perspective view of the camera module according to an embodiment of the present disclosure.

FIG. 3 is a view showing an arrangement relationship of the first lens module, reflection module, and second lens module of the camera module according to an embodiment of the present disclosure.

FIG. 4 is an exploded perspective view of the first lens module according to an embodiment of the present disclosure.

FIG. 5 is a perspective view of the reflection module according to an embodiment of the present disclosure.

FIG. 6 is an exploded perspective view of the reflection module according to an embodiment of the present disclosure.

FIG. 7 is an exploded bottom perspective view of the reflection module according to an embodiment of the present disclosure.

FIG. 8 is a perspective view of a first auxiliary member according to an embodiment of the present disclosure.

FIGS. 9A to 9C are views showing a reflection holder rotated about a first rotation axis according to an embodiment of the present disclosure.

FIGS. 10A to 10C are views showing a rotation holder being rotated about a second rotation axis according to an embodiment of the present disclosure.

FIG. 11 is an exploded perspective view of the second lens module according to an embodiment of the present disclosure.

FIG. 12 is a bottom perspective view of the second lens module according to an embodiment of the present disclosure.

FIG. 13 is a side view of the reflection module according to an embodiment of the present disclosure.

FIG. 14 is a side view of the reflection module according to another embodiment of the present disclosure.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items; likewise, “at least one of” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as “above,” “upper,” “below,” “lower,” and the like, may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above,” or “upper” relative to another element would then be “below,” or “lower” relative to the other element. Thus, the term “above” encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term “may” with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

An aspect of the present disclosure is to provide a reflection module with improved structural reliability against external impacts and a camera module that includes the same.

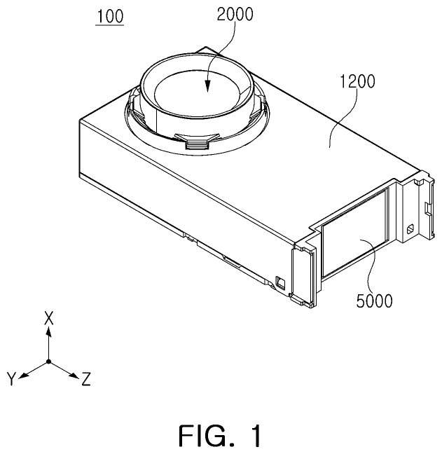

FIG. 1 is a perspective view of a camera module according to an embodiment of the present disclosure.

Referring to FIG. 1, a camera module 100, according to an embodiment of the present disclosure, may convert a path of incident light at least once. In an embodiment, the camera module 100 may convert the incident light path from a first optical axis direction (X-axis direction) to a second optical axis direction (Z-axis direction). The camera module 100 may be long in the second optical axis direction (Z-axis direction).

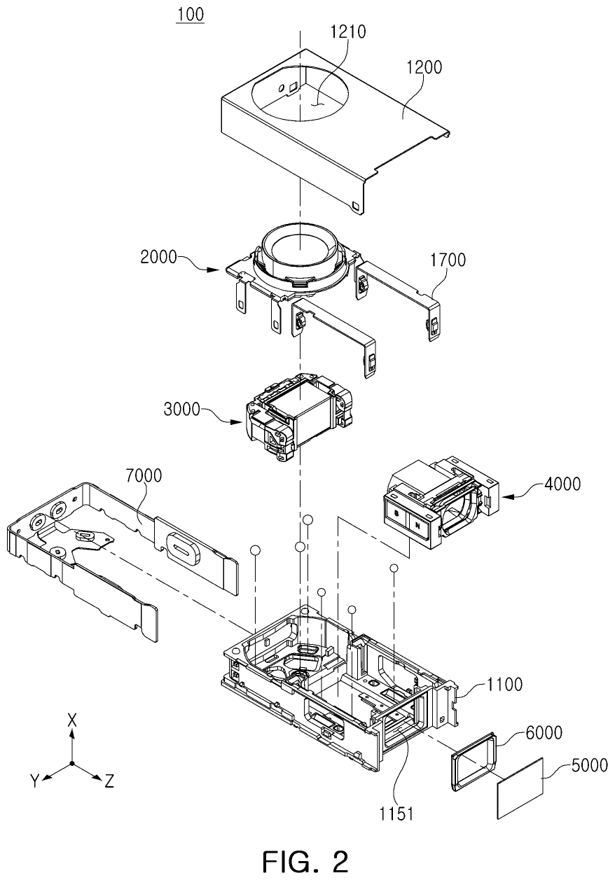

FIG. 2 is a schematic exploded perspective view of the camera module according to an embodiment of the present disclosure.

Referring to FIG. 2, the camera module 100, according to an embodiment of the present disclosure, may include a housing 1100 and a case 1200, forming its exterior, a first lens module 2000, a reflection module 3000, a second lens module 4000, and an image sensor 5000.

The housing 1100 may be a box-shaped member with an internal space. For example, the housing 1100 may be the box-shaped member which is long in the second optical axis direction (Z-axis direction), and the first lens module 2000, the reflection module 3000, the second lens module 4000, and the image sensor 5000 may be disposed in the housing 1100 approximately in the second optical axis direction (Z-axis direction). Alternatively, unlike what is shown in the drawings, the plurality of housings may be provided, and the components may be disposed in the plurality of housings individually or together with other components.

The case 1200 may be coupled to the top of the housing 1100 to cover an internal space thereof. The case 1200 may serve to protect the components disposed in the housing 1100. In addition, the case 1200 may serve to shield electromagnetic waves, and to this end, the case 1200 may be formed of a metal material.

The case 1200 may include an opening 1210, and the first lens module 2000 may be disposed in the opening 1210. Therefore, light reflected from an external subject may be incident on the first lens module 2000.

The first lens module 2000, the reflection module 3000, the second lens module 4000, and the image sensor 5000 may be sequentially disposed in the housing 1100 along the incident light path. That is, light reflected from the external subject may be incident on the first lens module 2000, may sequentially pass through the reflection module 3000 and the second lens module 4000, and then reach the image sensor 5000.

The image sensor 5000 may be coupled to one side surface of the housing 1100. One side surface of the housing 1100 may include an opening 1151, and the image sensor 5000 may be coupled to the housing 1100 to have an imaging surface exposed to the internal space of the housing 1100 through the opening 1151.

The image sensor 5000 may convert incident light into an electrical signal. The electrical signal generated from the image sensor 5000 may be output as an image through a display of a portable electronic device.

A filter unit 6000 may be further disposed in front of the image sensor 5000. The filter unit 6000 may serve to block light of a specific wavelength region among light passing through the second lens module 4000 and incident on the image sensor 5000. For example, the filter unit 6000 may include an infrared ray (IR) cut filter to block light in an infrared wavelength region.

In addition, a board 7000 mounted with a coil or the like may be disposed in the housing 1100 or coupled to the housing 1100 outside of the housing 1100.

The housing 1100 may include a through hole in a portion where the board 7000 is disposed. The board 7000 may be coupled to the housing 1100 for one surface of the board 700 that is mounted with the coil or the like to be exposed to the internal space of the housing 1100 through the through hole.

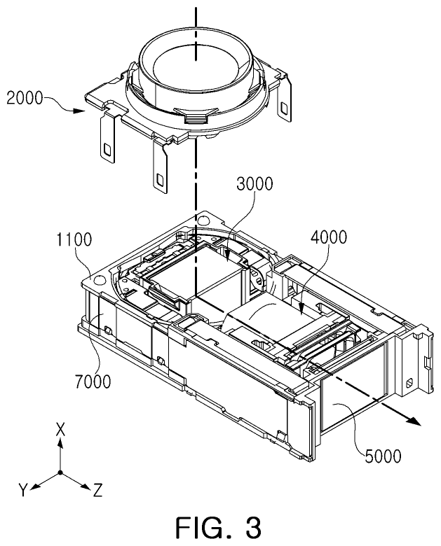

FIG. 3 is a view showing an arrangement relationship of the first lens module, reflection module, and second lens module of the camera module according to an embodiment of the present disclosure.

Referring to FIG. 3, the first lens module 2000 and the reflection module 3000 may be disposed in the first optical axis direction (X-axis direction), and the reflection module 3000 and the second lens module 4000 may be disposed in the second optical axis direction (Z-axis direction).

The specification describes an embodiment in which the camera module 100 includes the first lens module 2000. However, in another embodiment, the camera module 100 may not include the first lens module 2000.

The first lens module 2000 or the second lens module 4000 may include one or more lenses that refract incident light.

The reflection module 3000 may include a reflection member 3100 that converts the incident light path. For example, the reflection member 3100 may be a prism, and the reflection member may not necessarily have to be a prism.

The reflection member 3100 may convert the incident light path from approximately the first optical axis direction (X-axis direction) to approximately the second optical axis direction (Z-axis direction). That is, the path of incident light that is incident in the first optical axis direction (X-axis direction) may be changed to be in the second optical axis direction (Z-axis direction) on a reflection surface 3130 of the reflection member 3100. A first optical axis (X-axis) and a second optical axis (Z-axis) may intersect each other at the reflection surface 3130 of the reflection member 3100, and an intersection point of the first optical axis (X-axis) and the second optical axis (Z-axis) may approximately coincide with the center of the reflection surface 3130.

According to an embodiment of the present disclosure, the camera module 100 may stabilize the optical image by moving the reflection module 3000, and adjust the focus by moving the second lens module 4000.

Hereinafter, the first lens module 2000, the reflection module 3000, and the second lens module 4000 are described in detail with respect to the internal space of the housing 1100.

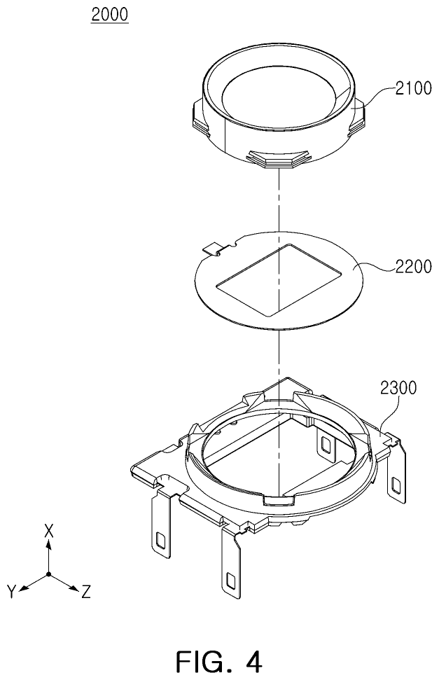

FIG. 4 is an exploded perspective view of the first lens module according to an embodiment of the present disclosure.

Referring to FIG. 4, the first lens module 2000 may include a first lens barrel 2100 accommodating one or more lenses, a first lens holder 2300 mounted with the first lens barrel 2100, and a spacer 2200 disposed between the first lens barrel 2100 and the first lens holder 2300.

The first lens barrel 2100 may be disposed in the opening 1210 of the case 1200. Accordingly, light reflected from the external subject may be incident on a lens accommodated in the first lens barrel 2100, and incident light may be incident to be approximately parallel to the first optical axis (X-axis).

The first lens module 2000 may be disposed in the first optical axis direction (X-axis direction) together with the reflection module 3000. Incident light that is incident on the first lens module 2000 may pass through the first lens module 2000 and then be incident on the reflection module 3000. To this end, the first lens holder 2300 and the spacer 2200 may each include an opening to allow incident light to pass therethrough.

An opening area of the spacer 2200 may be smaller than that of the first lens holder 2300. In addition, the spacer 2200 may include a light blocking part disposed along the perimeter of the opening, and blocking unnecessary light.

In an embodiment, the first lens module 2000 may be coupled to the housing 1100 by means of the first lens holder 2200. In this case, the first lens module 2000 may be a fixed member that is not moved while the camera module 100 performs the optical image stabilization function or the autofocus function. However, in another embodiment, the first lens module 2000 may be coupled to the reflection module 3000 and moved together with the reflection module 3000 while the camera module 100 performs the optical image stabilization function.

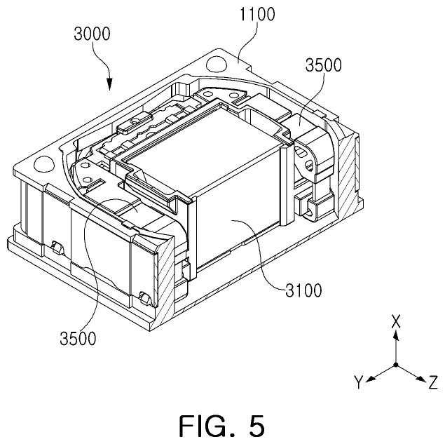

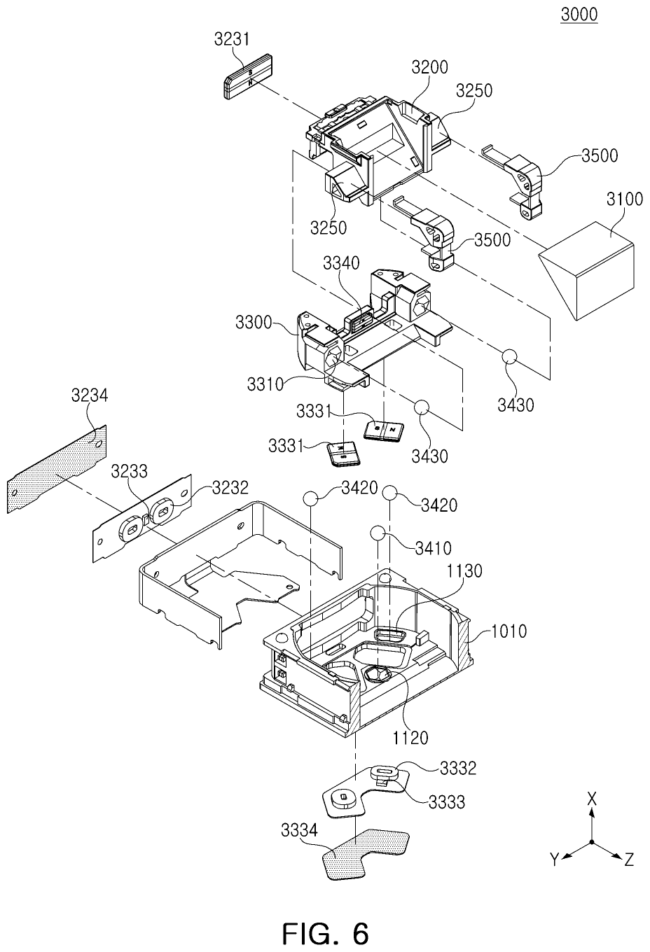

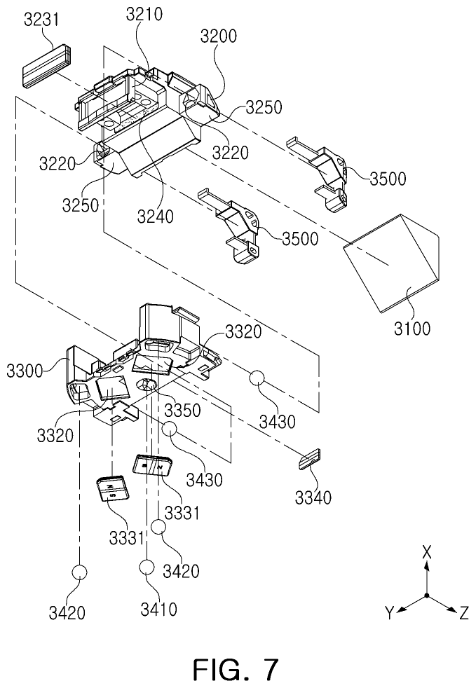

FIG. 5 is a perspective view of the reflection module according to an embodiment of the present disclosure; FIG. 6 is an exploded perspective view of the reflection module according to an embodiment of the present disclosure; and FIG. 7 is an exploded bottom perspective view of the reflection module according to an embodiment of the present disclosure.

The reflection module 3000 may include the reflection member 3100 converting the path of incident light passing through the first lens module 2000, a reflection holder 3200 mounted with the reflection member 3100, and a rotation holder 3300 supporting the reflection holder 3200. The rotation holder 3300 may be supported by the housing 1100.

The reflection member 3100 may be mounted on the reflection holder 3200 for the reflection surface to be disposed on a mounting surface of the reflection holder 3200.

The reflection holder 3200 may be moved relative to the rotation holder 3300 while being mounted with the reflection member 3100. For example, the reflection holder 3200 may be rotated relative to the rotation holder 3300 about the first rotation axis (Y-axis). The first rotation axis (Y-axis) may be approximately perpendicular to both the first optical axis (X-axis) and the second optical axis (Z-axis).

A first ball group 3430 may be disposed between the reflection holder 3200 and the rotation holder 3300. The reflection holder 3200 may be rotatably supported by the rotation holder 3300 via the first ball group 3410.

The first ball group 3430 may form the first rotation axis (Y-axis), the rotation axis of the reflection holder 3200. For example, the first ball group 3430 may include two ball members spaced apart from each other in the first rotation axis direction (Y-axis direction). The number of ball members included in the first ball group 3430 may be changed.

In an embodiment, the first ball group 3430 may be disposed between a plurality of first accommodation grooves 3220 disposed in the reflection holder 3200 and a plurality of second accommodation grooves 3310 disposed in the rotation holder 3300. The number of the first accommodation grooves 3220 or the second accommodation grooves 3310 may correspond to the number of the ball members included in the first ball group 3430.

The first accommodation groove 3220 and the second accommodation groove 3310 may face each other in the second optical axis direction (Z-axis direction), and the first ball group 3430 may be disposed between the first accommodation groove 3220 and the second accommodation groove 3310 facing each other. The first ball group 3430 may form the first rotation axis (Y-axis) by being rotated in place while its different portions are respectively accommodated in the first accommodation groove 3220 and the second accommodation groove 3310. To this end, at least one of the plurality of first accommodation grooves 3220 and the second accommodation grooves 3310 may include three inclined surfaces for the ball member included in the first ball group 3430 to be supported by at least three points.

A magnetic material that generates a magnetic force (e.g., magnetic attraction) may be disposed on each of the reflection holder 3200 and the rotation holder 3300 for the reflection holder 3200 to be stably supported by the rotation holder 3300 while having the first ball group 3430 interposed therebetween.

In an embodiment, a first magnetic material 3240 may be disposed in the reflection holder 3200, and a second magnetic material 3340 may be disposed at the rotation holder 3300. For example, the first magnetic material 3240 may be a pulling yoke, and the second magnetic material 3340 may be a pulling magnet.

The first magnetic material 3240 and the second magnetic material 3340 may face each other in the second optical axis direction (Z-axis direction), and the magnetic attraction may act in the second optical axis direction (Z-axis direction) which is the direction in which the first magnetic material 3240 and the second magnetic material 3340 face each other. Therefore, the reflection holder 3200 may be supported by the rotation holder 3300 in the second optical axis direction (Z-axis direction).

The reflection holder 3200 may be supported by the rotation holder 3300 while having the first ball group 3430 interposed therebetween. In this state, a first auxiliary member 3500 may be coupled to the rotation holder 3300. For example, the first auxiliary member 3500 may be coupled to the rotation holder 3300 to surround a portion of the reflection holder 3200, thereby preventing the reflection holder 3200 from being separated from the rotation holder 3300. Details of the first auxiliary member 3500 are to be provided below.

The rotation holder 3300 may be moved relative to the housing 1100, together with the reflection holder 3200 supported by the rotation holder 3300. For example, the rotation holder 3300 may be rotated relative to the housing 1100 about the second rotation axis (X-axis). The second rotation axis (X-axis) may be approximately parallel to the first optical axis.

A second ball group 3410 and 3420 may be disposed between the rotation holder 3300 and the housing 1100. The rotation holder 3300 may be rotatably supported by the housing 1100 via the second ball group 3410 and 3420.

The second ball group 3410 and 3420 may include one rotation axis ball 3410 and the plurality of guide balls 3420. The rotation axis ball 3410 may form the second rotation axis (X-axis), and the plurality of guide balls 3420 may assist the rotation of the rotation holder 3300 about the second rotation axis (X-axis). For example, the plurality of guide balls 3420 may include two ball members spaced apart from the rotation axis ball 3410. The number of the ball members included in the guide ball 3420 may be changed.

In an embodiment, the rotation axis ball 3410 may be disposed between a third accommodation groove 3350 disposed in the rotation holder 3300 and a fourth accommodation groove 1120 disposed in the housing 1100.

The third accommodation groove 3350 and the fourth accommodation groove 1120 may face each other in the first optical axis direction (X-axis direction), and the axis rotation ball 3410 may be disposed between the third accommodation groove 3350 and the fourth accommodation groove 1120 facing each other. The rotation axis ball 3410 may form the second rotation axis (X-axis) by being rotated in place while its different portions are respectively accommodated in the third accommodation groove 3350 and the fourth accommodation groove 1120. To this end, at least one of the third accommodation groove 3350 and the fourth accommodation groove 1120, may include three inclined surfaces for the rotation axis ball 3410 to be supported by at least three points.

In addition, in an embodiment, the plurality of guide balls 3420 may be disposed between a plurality of first guide grooves 3320 disposed in the rotation holder 3300 and a plurality of second guide grooves 1130 disposed in the housing 1100. The number of the first guide grooves 3320 or the second guide grooves 1130 may correspond to the number of the plurality of guide balls 3420.

The first guide groove 3320 and the second guide groove 1130 may face each other in the first optical axis direction (X-axis direction), and the plurality of guide balls 3420 may be disposed between the first guide groove 3320 and the second guide groove 1130 facing each other. The guide ball 3420 may perform a rolling motion to support the rotation of the rotation holder 3300 while having different portions respectively accommodated in the first guide groove 3320 and the second guide groove 1130. The first guide groove 3320 and the second guide groove 1130 may extend approximately in the rotation direction of the rotation holder 3300.

The reflection module 3000 may include a driving unit generating driving force for rotating the reflection holder 3200 and the rotation holder 3300. The reflection module 3000 may include a first driving unit 3230, generating the driving force for rotating the reflection holder 3200, about the first rotation axis (Y-axis), and a second driving unit 3330, generating the driving force for rotating the rotation holder 3300 about the second rotation axis (X-axis).

The first driving unit 3230 may include a first driving magnet 3231 and a first driving coil 3232. The first driving magnet 3231 and the first driving coil 3232 may face each other in the second optical axis direction (Z-axis direction).

The first driving magnet 3231 may be disposed on the reflection holder 3200. For example, the reflection holder 3200 may include an extension 3210 disposed between the housing 1100 and the rotation holder 3300, and the first driving magnet 3231 may be disposed on the extension 3210 of the reflection holder 3200.

The first driving coil 3232 may be disposed in the housing 1100. For example, the first driving coil 3232 may be mounted on one surface of the board 7000, and coupled to the housing 1100 via the board 7000.

The first driving magnet 3231 may be sequentially magnetized into a north (N) pole (or a south(S) pole), a neutral region, and an S pole (or an N pole) in the first optical axis direction (X-axis direction). The first driving coil 3232 may include one or more coils facing the first driving magnet 3231. The first driving magnet 3231 and the first driving coil 3232 may generate the driving force in a direction perpendicular to the direction in which these two components face each other, and by this driving force, the reflection holder 3200 may be rotated about the first rotation axis (Y-axis).

The first driving unit 3230 may include a first position sensor 3233 detecting a position of the first driving magnet 3231. One or more first position sensors 3233 may be provided, and mounted on one surface of the board 7000 together with the first driving coil 3232 to face the first driving magnet 3231.

The first position sensor 3233 may be a magnetic sensor detecting the position (movement amount) of the first driving magnet 3231 by detecting a change in magnetic flux. In an embodiment, the first position sensor 3233 may face the neutral region of the first driving magnet 3231 and effectively detect the change in the magnetic flux.

The first driving unit 3230 may include a first yoke 3234 disposed on the back of the first driving coil 3232. That is, the first yoke 3234 may be disposed on a surface of the board 7000 opposite to its one surface on which the first driving coil 3232 or the like is mounted. The first yoke 3234 may be a magnetic material and may focus on a magnetic force line generated in the first driving magnet 3231. Accordingly, the magnetic force line generated in the first driving magnet 3231 may pass through the first driving coil 3232 more intensively.

The second driving unit 3330 may include a second driving magnet 3331 and a second driving coil 3332. The second driving magnet 3331 and the second driving coil 3332 may face each other in the first optical axis direction (X-axis direction).

The second driving magnet 3331 may be disposed on the rotation holder 3300. For example, the second driving magnet 3331 may be disposed on a bottom surface of the rotation holder 3300.

The second driving coil 3332 may be disposed in the housing 1100. For example, the second driving coil 3332 may be mounted on one surface of the board 7000, and coupled to the housing 1100 via the board 7000.

The second driving magnet 3331 may include two magnets sequentially magnetized into the N pole (or the S pole), the neutral region, and the S pole (or the N pole) approximately in the rotation direction of the rotation holder 3300. One or more first driving coils 3332 may be provided and face at least one of the magnets included in the second driving magnet 3331. The second driving magnet 3331 and the second driving coil 3332 may generate the driving force in a direction perpendicular to the direction in which these two components face each other, and by this driving force, the rotation holder 3300 may be rotated about the second rotation axis (X-axis).

The second driving unit 3330 may include a second position sensor 3333 detecting the position of the second driving magnet 3331. One or more second position sensor 3333 may be provided, and mounted on one surface of the board 7000 together with the second driving coil 3332 to face at least one of the magnets included in the second driving magnet 3331.

The second position sensor 3333 may be a magnetic sensor detecting the position (movement amount) of the second driving magnet 3331 by detecting the change in the magnetic flux. In an embodiment, the second position sensor 3333 may face the neutral region of the second driving magnet 3331 and effectively detect the change in the magnetic flux.

The second driving unit 3330 may include a second yoke 3334 disposed on the back of the second driving coil 3332. That is, the second yoke 3334 may be disposed on a surface of the board 7000 opposite to its one surface on which the second driving coil 3332 or the like is mounted.

In an embodiment, the second yoke 3334 may be a magnetic material. The second yoke 3234 may focus on a magnetic force line generated in the second driving magnet 3331. Accordingly, the magnetic force line generated in the second driving magnet 3331 may pass through the second driving coil 3332 more intensively.

In addition, the magnetic force (e.g., magnetic attraction) may be generated between the second yoke 3334 and the second driving magnet 3331. For example, the second yoke 3334 may be attracted to the first optical axis direction (X-axis direction), in which the second yoke 3334 faces the second driving magnet 3331. That is, the second yoke 3334 may serve as the pulling yoke, and the rotation holder 3300 may be supported by the housing 1100 in the first optical axis direction (X-axis direction) by means of the magnetic force between the second yoke 3334 and the second driving magnet 3331.

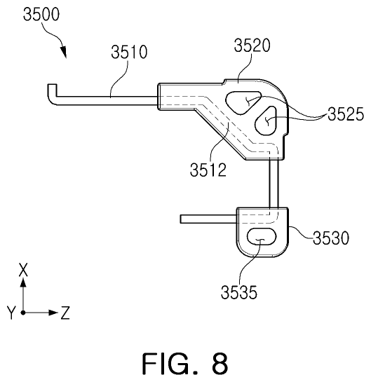

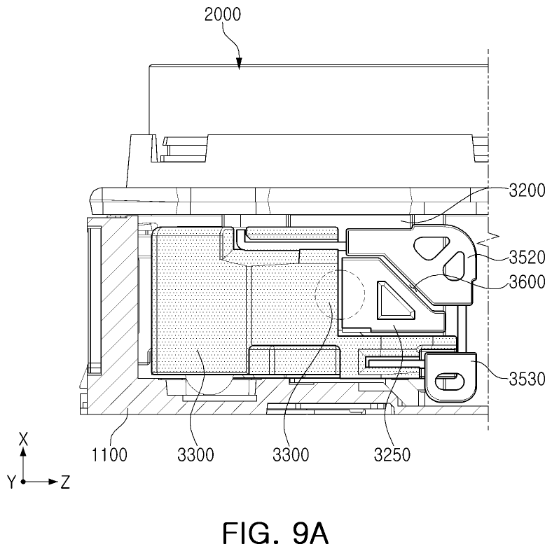

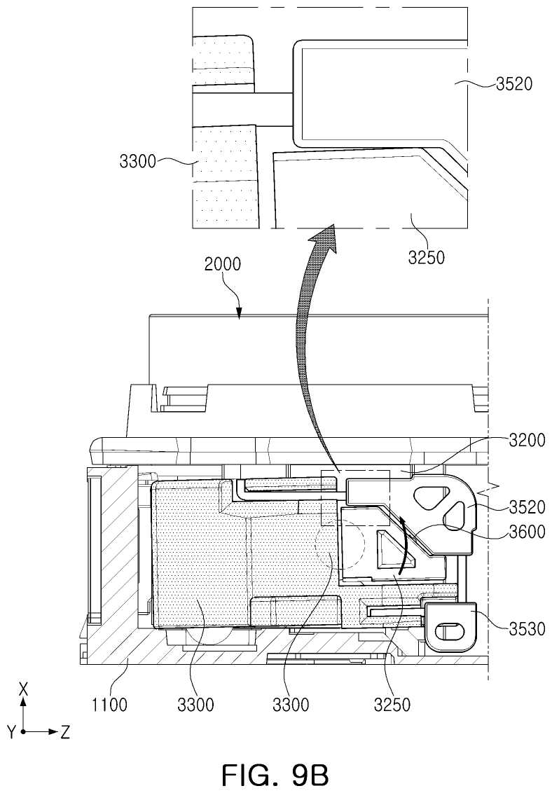

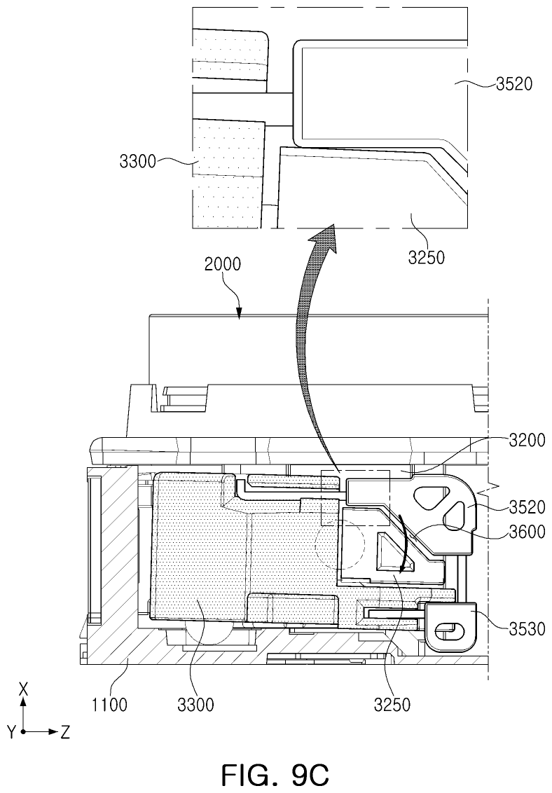

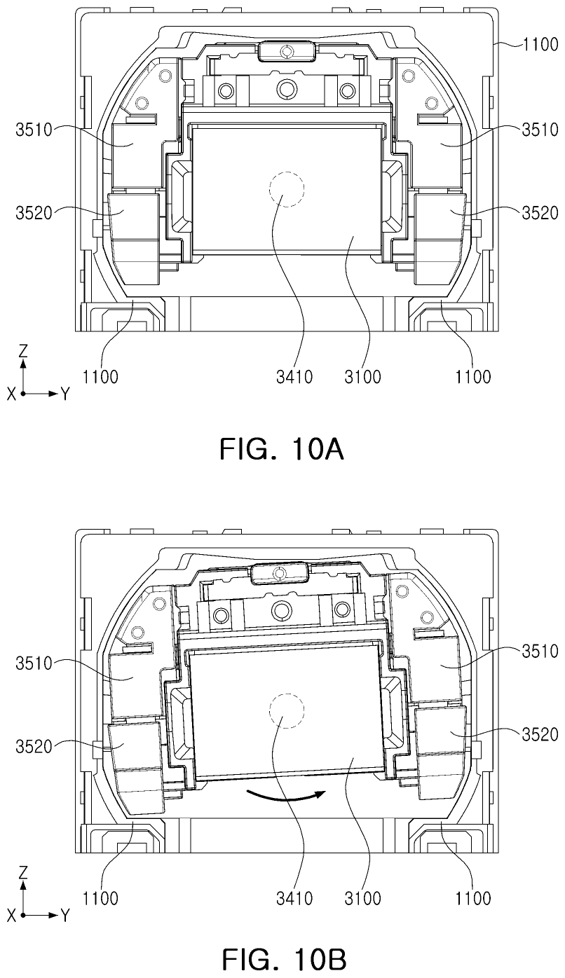

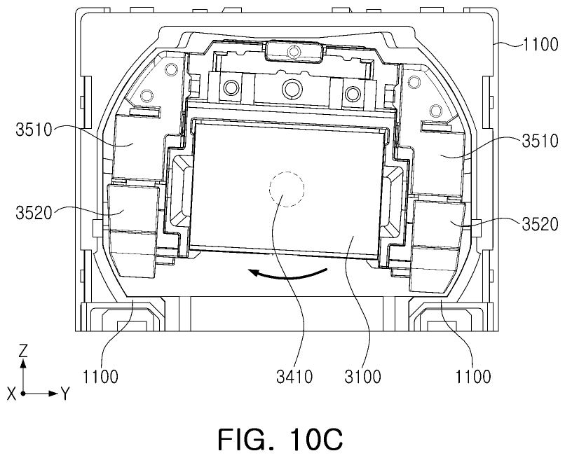

FIG. 8 is a perspective view of the first auxiliary member according to an embodiment of the present disclosure. FIGS. 9A to 9C are views showing the reflection holder rotated about the first rotation axis according to an embodiment of the present disclosure. FIGS. 10A to 10C are views showing that the rotation holder is rotated about the second rotation axis according to an embodiment of the present disclosure.

According to an embodiment of the present disclosure, the reflection module 3000 may include the first auxiliary member 3500 to regulate a rotation range of the reflection module 3000 and protect its components when an external impact is applied thereto.

The reflection holder 3200 may be supported by the rotation holder 3300 while having the first ball group 3430 interposed therebetween. The rotation holder 3300 may be supported by the housing 1100 while having the second ball group 3410 and 3420 interposed therebetween. In this state, the first auxiliary member 3500 may be coupled to the rotation holder 3300 to surround the reflection holder 3200.

The reflection holder 3200 may include protrusions 3250 on both sides in the first rotation axis direction (Y-axis direction). The protrusion 3250 may extend in the first rotation axis direction (Y-axis direction). The protrusion 3250 may include the first accommodation groove 3220, and the first ball group 3430 may be disposed therein.

The first auxiliary member 3500 may be coupled to the rotation holder 3300 to surround the protrusion 3250 of the reflection holder 3200. The first auxiliary member 3500 may be coupled to the rotation holder 3300 while having a distance 3600 from the reflection holder 3200 so as not to interfere with the rotation of the reflection holder 3200 relative to the rotation holder 3300.

The first auxiliary member 3500 may include a frame 3510 and first and second buffer members 3520 and 3530 disposed on the frame 3510.

The frame 3510 may be made of a material having structural rigidity, such as stainless steel. However, the material of the frame 3510 is not limited thereto. The frame 3510 may be approximately “C” shaped, with one end and the other, respectively, coupled to the rotation holder 3300.

Referring to the drawing, the frame 3510 may include an inclined portion 3512 which is cut obliquely to be diagonal to a corner (hereinafter, an upper corner) of the reflection holder 3200 that is positioned on its upper side. In an embodiment, the inclined portion 3512 may extend obliquely to the first rotation axis (Y-axis) or the second rotation axis (X-axis). The inclined portion 3512 may improve the structural rigidity of the frame 3510 by dispersing a stress concentrated on the corner when the impact is applied to the frame 3510.

The inclined portion 3512 of the frame 3510 may face the protrusion 3250 of the reflection holder 3200. The upper corner of the protrusion 3250 may be oblique to correspond to the inclined portion 3512. In detail, the protrusion 3250 may face the first buffer member 3520, which is described below, surrounding the inclined portion 3512, and the first buffer member 3520 may have a surface facing the protrusion 3250 and inclined like the inclined portion 3512.

The frame 3510 may include the first and second buffer members 3520 and 3530. The first and second buffer members 3520 and 3530 may be coupled to the corners of the frame 3510. For example, the first buffer member 3520 may be disposed at the upper corner of the frame 3510, that is, the inclined portion 3512, and the second buffer member 3530 may be disposed at a lower corner of the frame 3510. That is, the first buffer member 3520 and the second buffer member 3530 may be disposed on the frame 3510 and spaced apart from each other in the first optical axis direction (X-axis direction or second rotation axis direction).

The first or second buffer member 3520 or 3530 may entirely surround the upper or lower corner of the frame 3510 and protrude toward a counterpart member, for example, the housing 1100. Therefore, when the external impact is applied thereto, the first or second buffer member 3520 or 3530 may prevent direct collision between the housing 1100 and the rotation holder 3300.

The first buffer member 3520 may form the upper corner of the first auxiliary member 3500 by replacing the inclined portion 3512 of the frame 3510. For example, the first buffer member 3520 may protrude to be approximately perpendicular to the inclined portion 3512.

The distance between the first buffer member 3520 and the housing 1100 in the second optical axis direction (Z-axis direction) may be closer than the distance between the rotation holder 3300 and the housing 1100 in the second optical axis direction (Z-axis direction).

The second buffer member 3530 may surround the lower corner of the frame 3510 and protrude toward a bottom surface of the housing 1100. For example, a distance between the second buffer member 3530 and the housing 1100 in the first optical axis direction (X-axis direction) may be closer than the distance between the rotation holder 3300 and the housing 1100 in the first optical axis direction (X-axis direction). When the impact is applied thereto in the first optical axis direction (X-axis direction), the second buffer member 3530 may prevent the direct collision between the rotation holder 3300 and the housing 1100 facing in the first optical axis direction (X-axis direction), and absorb the impact.

The first or second buffer member 3520 or 3530 may be made of an elastic material to absorb the impact continuously. However, the material of the first or second buffer member 3520 or 3530 is not limited thereto.

The first or second buffer member 3520 or 3530 may include a curved surface. For example, the first or second buffer member 3520 or 3530 may have a region facing the counterpart member, and at least a portion of this region may have the curved surface. Accordingly, the first or second buffer member 3520 or 3530 may efficiently absorb the impact with the counterpart member that is caused by the rotation operation of the reflection module 3000.

In addition, the first or second buffer member 3520 or 3530 may include a damping hole 3525 or 3535 passing through its thickness. The damping hole 3525 or 3535 may be formed in a portion other than a portion of the first or second buffer member 3520 or 3530 that surrounds the frame 3510. The damping hole 3525 or 3535 may reduce noise occurring during the operation of the reflection module 3000.

Referring to FIGS. 9A through 9C, the reflection holder 3200 may be rotated relative to the rotation holder 3300 about the first rotation axis (Y-axis). As the reflection holder 3200 is rotated, the distance 3600 between the reflection holder 3200 and the first auxiliary member 3500 may be changed. When the reflection holder 3200 rotates at a predetermined angle or more, the protrusion 3250 of the reflection holder 3200 may come into contact with the first buffer member 3520 of the first auxiliary member 3500 that faces the protrusion 3250. Accordingly, the rotation range of the reflection holder 3200 may be limited. The reflection holder 3200 may first come into contact with the first buffer member 3520, thus preventing the collision between the reflection holder 3200 and the rotation holder 3300, which is the counterpart member, or alleviating a collision impact.

Referring to FIGS. 10A through 10C, the rotation holder 3300 may be rotated relative to the housing 1100 about the second rotation axis (X-axis).

In an embodiment, the maximum rotation angle of the rotation holder 3300 about the second rotation axis (X-axis) may be greater than the maximum rotation angle of the reflection holder 3200 about the first rotation axis (Y-axis) described above. That is, the rotation holder 3300 may be rotated while having a greater rotation range than the reflection holder 3200.

Meanwhile, another embodiment of the present disclosure may omit the rotation holder 3300 of the reflection module 3000.

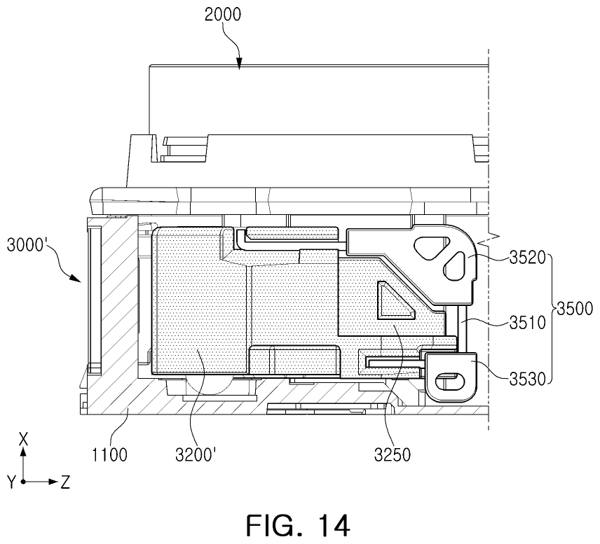

FIG. 13 is a side view of the reflection module according to an embodiment of the present disclosure. FIG. 14 is a side view of the reflection module according to another embodiment of the present disclosure.

Referring to FIG. 13, the reflection module 3000, according to an embodiment of the present disclosure, may include the reflection holder 3200 mounted with the reflection member 3100 and the rotation holder 3300 supporting the reflection holder 3200.

On the other hand, a reflection module 3000′, according to another embodiment of the present disclosure, may include a reflection member 3100′ and a holder 3200′ mounted with the reflection member 3100′. That is, the reflection module 3000′ may omit the rotation holder 3300.

In another embodiment of the present disclosure, the first auxiliary member 3500 may be coupled to the holder 3200′. Except that the first auxiliary member 3500 is coupled to the holder 3200′ instead of the rotation holder 3300, the other features related to the first auxiliary member 3500 may be the same as the above descriptions.

In another embodiment of the present disclosure, the holder 3200′ may be rotated relative to the housing 1100 about the first rotation axis (Y-axis) or the second rotation axis (Y-axis).

Meanwhile, as the rotation holder 3300 is omitted, the components disposed at the rotation holder 3300 in the reflection module 3000, according to an embodiment of the present disclosure, may be disposed at the holder 3200′, and some of the components may have changed positions.

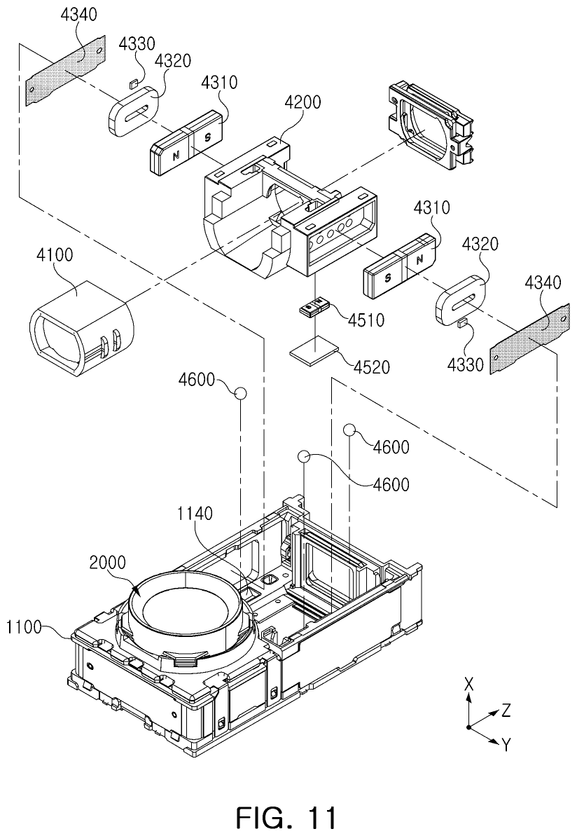

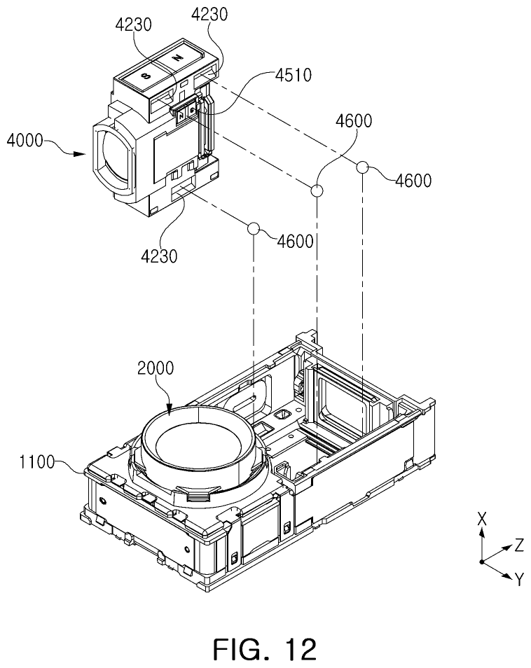

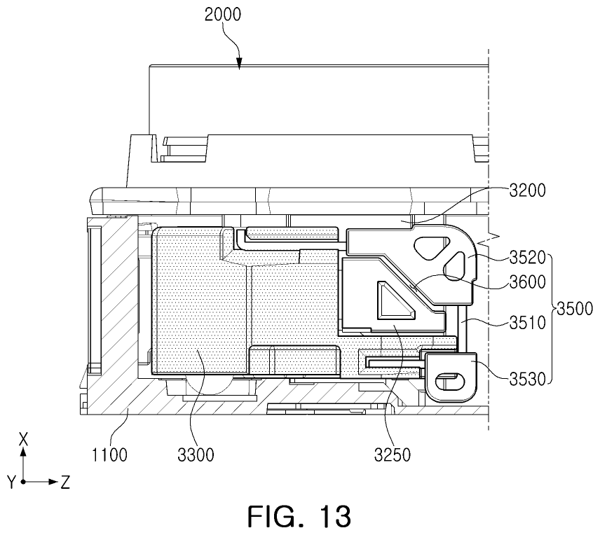

FIG. 11 is an exploded perspective view of the second lens module according to an embodiment of the present disclosure. FIG. 12 is a bottom perspective view of the second lens module according to an embodiment of the present disclosure.

Referring to FIG. 11 and the like, the second lens module 4000 may include a second lens barrel 4100 accommodating one or more lenses and a second lens holder 4200 mounted with the second lens barrel 4100.

The second lens barrel 4100 may include one or more lenses arranged in the second optical axis direction (Z-axis direction). The second lens holder 4200 may be supported by the housing 1100 while being mounted with the second lens barrel 4100.

A third ball group 4600 may be disposed between the second rotation holder 4200 and the housing 1100. The second lens holder 4200 may be movably supported by the housing 1100 via the third ball group 4600.

The third ball group 4600 may include three ball members spaced apart from one another in the second optical axis direction (Z-axis direction). The third ball group 4600 may include three or more ball members, and the number of ball members included in the third ball group 4600 may be changed.

Three ball members included in the third ball group 4600 may support one side or the other side of the second lens holder 4200. That is, one side and the other side of the second lens holder 4200 may be supported by at least one of the ball members.

The third ball group 4600 may be disposed between a plurality of third guide grooves 4230 disposed in the second lens holder 4200 and a plurality of fourth guide grooves 1140 disposed in the housing 1100. The numbers of the third guide grooves 4230 and the fourth guide grooves 1140 may correspond to the number of the ball members included in the third ball group 4600.

The third guide groove 4230 and the fourth guide groove 1140 may face each other in the first optical axis direction (X-axis direction), and the third ball group 4600 may be disposed between the third guide groove 4230 and the fourth guide groove 1140. The plurality of ball members included in the third ball group 4600 may each perform the rolling motion to support the movement of the second lens holder 4200 while having different portions respectively accommodated in the third guide groove 4230 and the fourth guide groove 1140. The third guide groove 4230 and the fourth guide groove 1140 may each extend approximately in a movement direction of the second lens holder 4200, that is, the second optical axis direction (Z-axis direction).

A magnetic material that generates the magnetic force (e.g., magnetic attraction) may be disposed on each of the second rotation holder 4200 and the housing 1100 for the second lens holder 4200 to be stably supported by the housing 1100 while having the third ball group 4600 interposed therebetween.

In an embodiment, a third magnetic material 4510 may be disposed on the second lens holder 4200, and a fourth magnetic material 4520 may be disposed in the housing 1100. For example, the third magnetic material 4510 may be the pulling magnet, and the fourth magnetic material 4520 may be the pulling yoke.

The third magnetic material 4510 and the fourth magnetic material 4520 may face each other in the first optical axis direction (X-axis direction). The magnetic attraction may act in the first optical axis direction (X-axis direction), which is the direction in which the third magnetic material 4510 and the fourth magnetic material 4520 face each other. Therefore, the second lens holder 4200 may be supported by the housing 1100 in the first optical axis direction (X-axis direction).

To support a stable movement of the second lens holder 4200, the third magnetic material 4510 may be disposed in a support region formed by the third ball group 4600. For example, the third ball group 4600 may include three ball members, and the third magnetic material 4510 may be disposed in a triangular support region having three ball members as its vertices.

Meanwhile, while the second lens holder 4200 is moved in the second optical axis direction (Z-axis direction), the third ball group 4600 may perform the rolling motion in the second optical axis direction (Z-axis direction), thereby continuously changing the support region formed by three ball members. In an embodiment, the third magnetic material 4510 may be biased to one side of the second lens holder 4200 for the third magnetic material 4510 to be continuously positioned in the support region formed by the third ball group 4600 during the movement of the second lens holder 4200.

Referring to FIG. 12, the second lens holder 4200 may have one side supported at two points by two ball members of the third ball group 4600, and the other side supported at one point by one ball member. The third magnetic material 4510 may be biased to one side of the second lens holder 4200. That is, the distance between the third magnetic material 4510 and one side of the second lens holder 4200 may be smaller than the distance between the third magnetic material 4510 and the other side of the second lens holder 4200. Accordingly, even when the second lens holder 4200 is moved with a long stroke, an action point of the magnetic attraction acting between the third magnetic material 4510 and the fourth magnetic material 4520 may be stable in the changed support region of the third ball group 4600.

Meanwhile, the second lens holder 4200 may be supported by the housing 1100 while having the third ball group 4600 interposed therebetween. In this state, a second auxiliary member 1700 may be coupled to the second lens holder 4200.

The second auxiliary members 1700 may be coupled to the housing 1100 to surround both sides of the second lens holder 4200, thereby preventing the second lens holder 4200 from being separated from the housing 1100 that is caused by the external impact. In addition, the second auxiliary member 1700 may include a buffer member protruding in the second optical axis direction (Z-axis direction) which is the movement direction of the second lens holder 4200. The buffer members may be disposed on one surface of the second auxiliary member 1700 that faces the housing 1100 and the other surface of the second auxiliary member 1700 that faces the second lens holder 4200 to thus serve to regulate a movement range of the second lens holder 4200 and absorb the impact.

The second lens module 4000 may include a third driving unit 4300, generating driving force to move the second lens holder 4200.

The third driving unit 4300 may include a third driving magnet 4310, and a third driving coil 4320. The third driving magnet 4310, and the third driving coil 4320 may face each other in the direction (Y-axis direction) perpendicular to both the first optical axis and the second optical axis.

The third driving magnet 4310 may be disposed on the second lens holder 4200. For example, the third driving magnet 4310 may include two magnets, and two magnets may be disposed on both surfaces of the second lens holder 4200.

The third driving coil 4320 may be disposed in the housing 1100. For example, the third driving coil 4320 may be mounted on one surface of the board 7000, and coupled to the housing 1100 via the board 7000.

The third driving magnet 4310 may include two magnets sequentially magnetized into the N pole (or the S pole), the neutral region, and the S pole (or the N pole) in the movement direction of the second lens holder 4200. The third driving coil 4320 may include two magnets and two coils, respectively, facing each other. The third driving magnet 4310 and the second driving coil 4320 may generate the driving force in a direction perpendicular to the direction in which these two components face each other. By this driving force, the second lens holder 4200 may be moved in the second optical axis direction (Z-axis direction).

The third driving unit 4300 may include a third position sensor 4330 detecting a position of the third driving magnet 4310. One or more third position sensors 4330 may be provided, and mounted on one surface of the board 7000 together with the third driving coil 4320 to face at least one of the magnets included in the third driving magnet 4310.

The third position sensor 4330 may be a magnetic sensor detecting the position (movement amount) of the third driving magnet 4310 by detecting the change in the magnetic flux. In an embodiment, the third position sensor 4330 may face the neutral region of the third driving magnet 4310 and effectively detect the change in the magnetic flux.

The third driving unit 4300 may include a third yoke 4340 disposed on the back of the third driving coil 4320. That is, third yoke 4340 may be disposed on a surface of the board 7000 that is opposite to its one surface on which the third driving coil 4320 or the like is mounted. The third yoke 4340 may include the magnetic material, and may focus a magnetic force line generated in the third driving magnet 4310. Accordingly, the magnetic force line generated in the third driving magnet 4310 may pass through the third driving coil 4320 more intensively.

As set forth above, according to the embodiments of the present disclosure, the camera module may improve its structural reliability against the external impact to thus secure the improved optical image stabilization performance.

In addition, according to the embodiment, the camera module may reduce the noise occurring when the camera module is impacted or driven.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A reflection module comprising:
a reflection member configured to convert an incident light path;
a holder, with the reflection member disposed thereon, configured to rotate about a first rotation axis and a second rotation axis perpendicular to the first rotation axis;
a housing accommodating the holder; and
a first auxiliary member coupled to the holder, the first auxiliary member comprising a plurality of buffer members and a frame on which the plurality of buffer members are disposed,
wherein the frame comprises an inclined portion having at least a portion extending obliquely with respect to the first rotation axis or the second rotation axis.

2. The reflection module of claim 1, wherein the plurality of buffer members comprises:
a first buffer member disposed on the inclined portion; and
a second buffer member spaced apart from the first buffer member.

3. The reflection module of claim 2, wherein the second buffer member is spaced apart from the first buffer member in a second rotation axis direction.

4. The reflection module of claim 2, wherein each of the first buffer member and the second buffer member comprises a portion facing the housing, and
at least a part of the portion facing the housing has a curved contour.

5. The reflection module of claim 2, wherein each of the first buffer member and the second buffer member comprises one or more damping holes passing therethrough in a thickness direction.

6. The reflection module of claim 2, wherein the first buffer member protrudes toward a side surface of the housing for a distance between the housing and the first buffer member to be closer than a distance between the housing and the holder.

7. The reflection module of claim 2, wherein the second buffer member protrudes toward a bottom surface of the housing for a distance between the housing and the second buffer member to be closer than a distance between the housing and the holder.

8. The reflection module of claim 1, wherein the holder comprises:
a reflection holder, mounted with the reflection member, configured to rotate about the first rotation axis, and
a rotation holder, supporting the reflection holder, configured to rotate about the second rotation axis, and
wherein the first auxiliary member is coupled to the rotation holder to surround a portion of the reflection holder.

9. The reflection module of claim 8, wherein the reflection holder further comprises a protrusion extending in a first rotation axis direction, and
the first auxiliary member surrounds the protrusion.

10. The reflection module of claim 9, wherein the first auxiliary member is configured to have at least a portion of the inclined portion face the protrusion, and
a portion of the protrusion that faces the first auxiliary member extends to be parallel to the inclined portion.

11. The reflection module of claim 8, wherein the first auxiliary member is coupled to the rotation holder to be spaced apart from the housing and the reflection holder.

12. A camera module comprising:
a housing;
a reflection module, disposed in the housing, comprising a reflection member;
a lens module, disposed in the housing, comprising at least one lens; and
a first auxiliary member, disposed on at least one side of the reflection module, comprising a plurality of buffer members and a frame in which the plurality of buffer members are disposed,
wherein the frame has an inclined portion to which at least one of the plurality of buffer members is coupled.

13. The camera module of claim 12, wherein the reflection module comprises a holder, mounted with the reflection member, configured to rotate about the first rotation axis and the second rotation axis perpendicular to the first rotation axis, and
wherein the first auxiliary member is coupled to the holder.

14. The camera module of claim 12, wherein the plurality of buffer members comprises:
a first buffer member disposed on the inclined portion; and
a second buffer member spaced apart from the first buffer member.

15. The camera module of claim 12, wherein at least a portion of the plurality of buffer members has a curved contour.

16. The camera module of claim 12, wherein the plurality of buffer members comprises one or more damping holes passing therethrough in a thickness direction.
